(19) United States
(12) Patent Application Publication
(10) Pub. No.: US 2015/0161223 A1
(43) Pub. Date: Jun. 11, 2015

(54) INFORMATION PROCESSING DEVICE AND METHOD FOR MOVING DATA

(71) Applicant: FUJITSU LIMITED, Kawasaki-shi (JP)

(72) Inventor: Shinji Hiyama, Yokohama (JP)

(21) Appl. No.: 14/541,317

(22) Filed: Nov. 14, 2014

(30) Foreign Application Priority Data
Dec. 11, 2013 (JP) 2013-256428

(51) Int. Cl. G06F 17/30

(52) U.S. Cl. CPC G06F 17/30569

(57) ABSTRACT

An information processing device includes a first recording medium, a first storage unit, a second storage unit, and a processor. The first recording medium stores data in a first format. The first storage unit stores a first program for causing the device to access data in the first format and not causing the device to access data in a second format different from the first format. The second storage unit stores a second program for causing the device to access data in the first format and causing the device to access data in the second format. The processor is configured to select one of the first program and the second program and execute, upon selecting the second program, the second program to read first data stored in a second recording medium in the second format and write the first data in the first recording medium in the first format.

### CROSS-REFERENCE TO RELATED APPLICATION

This application is based upon and claims the benefit of priority from the prior Japanese Patent Application No. 2013-256428 filed on Dec. 11, 2013, the entire contents of which are incorporated herein by reference.

### FIELD

The embodiments discussed herein are related to an information processing device and a method for moving data.

### BACKGROUND

Information processing devices are being widely used as a server. The server provides users, who use terminal devices which are clients connected through a network, with functions and/or data as a service. The users of the terminal devices are normally able to arbitrarily use the service provided by the server.

Typically, there are a lot of users of the terminal devices where the server provides the service. Further, the server may frequently manage highly confidential data. For these reasons, a facility (e.g., a data center) where the server is installed is strictly managed/regulated so as to prevent the information from being taken out (e.g., leakage). In general, carrying a data-writable recording medium (e.g., universal serial bus (USB) memory) into a site (hereinafter, referred to as a “server room”) where the server is actually installed is strictly inhibited from a security point of view.

In the information processing device such as a server, firmware which is a program for performing a basic control for hardware resources is activated first and then an operating system (OS) which is a multifunction program compared to the firmware is started.

A recording medium may be carried into the server room in order to allow processing to be executed under the control of the firmware. The processing is, for example, a firmware update. The firmware update is normally performed under the control of the firmware to be updated.

For updating firmware, a firmware (at least a portion of the firmware) after having been updated is needed as data to be used for the update. In some cases, a program (hereinafter, referred to to as an “update program”) for performing the firmware update may be added to the data to be used for the update. A compact disc (CD) to which additional writing is not allowed is frequently used as the recording medium to which the update data for the firmware is to be written.

One or more file systems are included in the firmware. The file system is a program for managing data written on the recording medium. The format of the recording medium compatible with the firmware is limited by the included file system.

Up until now, Basic Input/Output System (BIOS) has been adopted as firmware in an information processing device such as a server. However, recently, firmware (hereinafter, referred to as an “EFI code”) compatible with Extensible Firmware Interface (EFI) is increasingly adopted. This is because the EFI code is firmware developed to overcome the problem that BIOS has many limitations.

A CD to which additional writing is not allowed may include, for example, a CD-ROM (read-only memory). A CD-ROM is formatted in a format (hereinafter, referred to as a “CDFS format”) by CD-ROM File System (CDFS) and BIOS is compatible with the CDFS format. However, the EFI code is incompatible with the CDFS format and the data stored in a CD-ROM is basically not accessed in accordance with the EFI code. Accordingly, conventionally, when a CD (CD-ROM) having the CDFS format is used for the processing (e.g., update) to be performed under the control of the EFI code, the data for the processing is formed as data which may be accessed in accordance with the EFI code and is written to the CD.

The EFI code is compatible with a file allocation table (FAT) format by a FAT file system. Accordingly, FAT formatted processing data is written onto a CDFS formatted CD. However, FAT formatted processing data is not able to be written onto a CD using a standardized method. Therefore, FAT formatted processing data to be written onto a CD is formed as an image (image data).

The image of FAT formatted processing data may be generated (obtained), for example, in such a manner that processing data is written into a FAT formatted recording medium (e.g., a USB memory or a hard disk) and the written FAT formatted processing data is read as an image. Such an image represents the contents of the processing data in the FAT format and thus the contents may also be accessed in accordance with the EFI code.

In order to generate a FAT formatted processing image, a cumbersome work is required to write the processing data onto the FAT formatted recording medium and read the written processing data as an image. Accordingly, it takes a long time to prepare a CD for processing. Further, in order to write the FAT formatted image onto a CD, a system environment is required in which a tool for the writing and hardware resources enabling the writing are provided. In this respect, it is considered to be important to make it possible to use a recording medium onto which data unable to be accessed in accordance with the firmware in a standardized method is written, in order to efficiently execute the processing necessary for the firmware installed on an information processing device such as a server.

Related techniques are disclosed in, for example, Japanese Laid-Open Patent Publication No. 2010-79821 and Japanese Laid-Open Patent Publication No. 2004-272764.

### SUMMARY

According to an aspect of the present invention, provided is an information processing device including a first recording medium, a first storage unit, a second storage unit, and a processor. The first recording medium is configured to store therein data in a first format. The first storage unit is configured to store therein a first program for causing the information processing device to access data in the first format and not causing the information processing device to access data in a second format different from the first format. The second storage unit is configured to store therein a second program for causing the information processing device to access data in the first format and causing the information processing device to access data in the second format. The processor is configured to select, as a target program to be executed, one of the first program and the second program. The processor is configured to execute, upon selecting the second program as the target program, the second program to read first data stored in a second recording medium in the second format and write the first data in the first recording medium in the first format. The second recording medium is different from the first recording medium.

The objects and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of an information processing device according to an embodiment;

FIG. 2 is a diagram illustrating an example of functions of a boot control program included in an EFI code; and

FIG. 3 is a flowchart illustrating an example of a flow of processing executed in accordance with an EFI code, an embedded OS and an update program.

### DESCRIPTION OF EMBODIMENTS

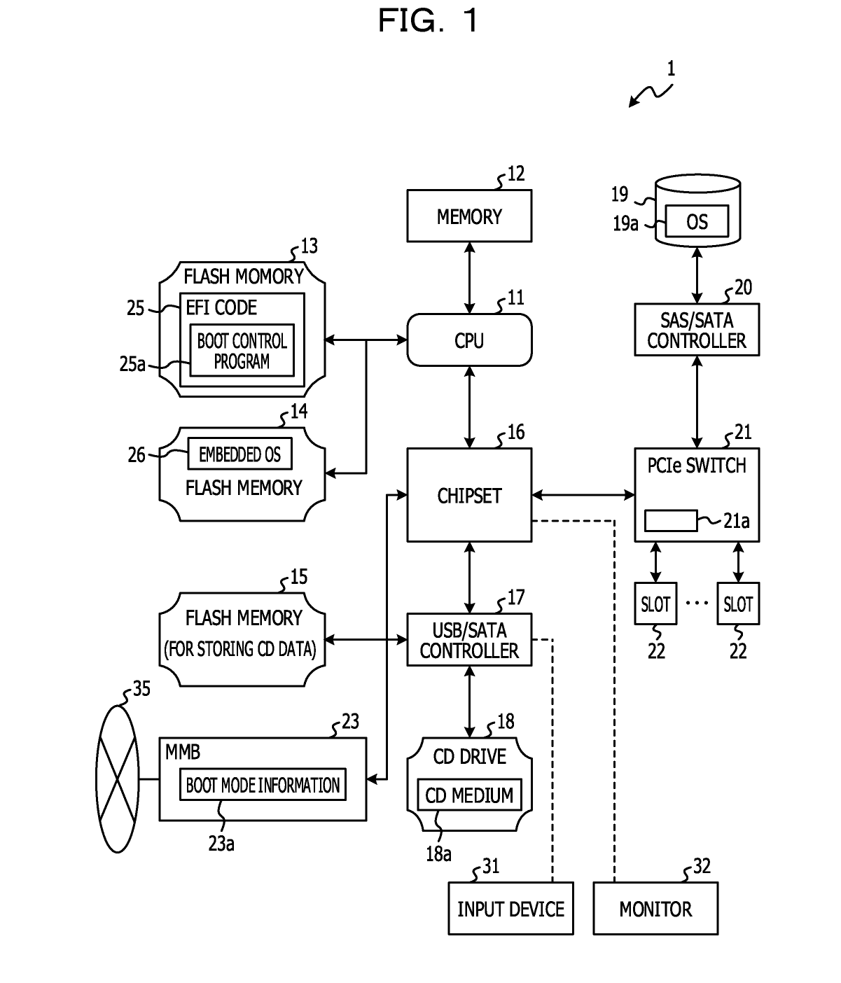

Hereinafter, descriptions will be made on embodiments in detail with reference to the drawings. FIG. 1 is a diagram illustrating an exemplary configuration of an information processing device according to an embodiment. An information processing device 1 according to the present embodiment is an information processing device installed in, for example, a data center as a server. Thus, the information processing device 1 is hereinafter referred to as a “server”.

As illustrated in FIG. 1, the server 1 includes a central processing unit (CPU) 11, a memory (e.g., memory module) 12, three flash memories 13, 14 and 15, a chipset 16, a USB/SATA (Serial ATA (Advanced Technology Attachment)) controller 17, a CD drive 18, a hard disk drive 19, a Serial Attached Small Computer System Interface (SAS)/SATA controller 20, a Peripheral Component Interconnect Express (PCIe) switch 21, a plurality of PCI slots 22, and an Management Board (MMB) 23.

The three flash memories 13, 14 and 15 are provided for storing an EFI code 25, for storing an embedded OS 26, and for copying data stored in a CD medium 18a mounted on the CD drive 18, respectively. The three flash memories 13, 14 and 15 are initialized in a FAT format so that the flash memories may be accessed in accordance with the EFI code 25.

The chipset 16 manages transmission and reception of data by the CPU 11 to and from the MMB 23, the USB/SATA controller 17, and the PCIe switch 21. Thus, the CPU 11 accesses the MMB 23, the CD medium 18a mounted on the CD drive 18, and the hard disk drive 19 through the chipset 16.

When a monitor 32 is connected to the server 1, the monitor 32 is connected to the chipset 16. When the monitor 32 has been connected to the chipset 16, the CPU 11 may generate a screen (image data) to be output to the monitor 32 as needed and output the generated screen to the chipset 16 in order to output the generated screen to the monitor 32. The monitor 32 may be installed on the server 1.

The MMB 23 is a management device which manages the server 1. The MMB 23 performs various operations such as monitoring of a state of hardware resources provided in the server 1, displaying various information, and power supply control including ON/OFF of power supply.

The MMB 23 is connected to a network (e.g., a local area network (LAN)) 35 and normally adapted to operate at all times in order to manage the server 1. Accordingly, a terminal device connected to the network 35 may perform various operations such as displaying various information and power supply control. According to the present embodiment, a boot mode may be set in the MMB 23 from the terminal device connected to the network 35. Boot mode information 23a in FIG. 1 indicates contents of the boot mode set from the terminal device. The boot mode information 23a is referenced by the CPU 11 when the server 1 is activated due to turning ON of the power supply or the system reset.

The USB/SATA controller 17 is connected with the flash memory 15 and the CD drive 18 in addition to the chipset 16. Accordingly, the USB/SATA controller 17 controls the CD drive 18, that is, accessing the mounted CD medium 18a, and accessing the flash memory 15 in accordance with an instruction sent from the CPU 11 through the chipset 16. The USB/SATA controller 17 is connected with the chipset 16 by USB, and the USB/SATA controller 17 is connected with the flash memory 15 and the CD drive 18 by SATA.

When an input device (e.g., a keyboard) 31 is connected to the server 1, the input device 31 is connected with the USB/SATA controller 17. When the input device 31 is connected with the USB/SATA controller 17, an operator becomes to be able to control the server 1 by manipulating the input device 31. The input device 31 may be installed in the server 1.

When the input device 31 is connected to the server 1, the operator also connects the monitor 32 to the server 1. Accordingly, the operator causes the server 1 to perform a desired processing by manipulating the input device 31 while viewing the screen being displayed on the monitor 32.

The hard disk drive 19 is a storage device storing an OS 19a and connected with a SAS/SATA controller 20. The hard disk drive 19 stores therein, for example, various application programs and data, in addition to the OS 19a.

The SAS/SATA controller 20 is connected with the PCIe switch 21. The instruction from the CPU 11 is notified to the SAS/SATA controller 20 through the chipset 16 and the PCIe switch 21. Thus, the SAS/SATA controller 20 controls the hard disk drive 19 in accordance with the instruction from the CPU 11. The SAS/SATA controller 20 is connected with the hard disk drive 19 by SAS or SATA, and the SAS/SATA controller 20 is connected with the PCIe switch 21 by PCIe.

Each slot 22 connected to the PCIe switch 21 is used to add, for example, an expansion card to the server 1. The PCIe switch 21 controls transmission and reception of data by the chipset 16 to and from each slot 22 (e.g., expansion card connected to the slot 22) and the SAS/SATA controller 20.

In the server 1, the EFI code 25 may be updated to fix bugs or add functions. The EFI code 25 needs to be updated under the control of the EFI code 25. However, from the security point of view, a recording medium to which additional writing is allowed is not permitted to be carried in the server room where the server 1 is installed. Accordingly, the data used for updating the EFI code 25 is required to be written into a recording medium to which additional writing is not allowed. According to the present embodiment, the CD medium 18a is assumed as the recording medium to which additional writing is not allowed, and the CD drive 18 is installed in the server 1 under the assumption. The CD drive 18 may be connected to the server 1 as needed.

The EFI code 25 is incompatible with the CD medium 18a, that is, the data stored in the CD medium 18a may basically not be accessed in accordance with the EFI code 25 using a standardized method,. When it is intended to write data onto the CD medium 18a in order to be accessed in accordance with the EFI code 25, a cumbersome work is needed and limitations on the system environment exists which is required on a device which writes data onto the CD medium 18a. Therefore, the time taken to prepare the CD medium 18a becomes longer and a rapid updating of the EFI code 25 becomes difficult. Thus, according to the present embodiment, the EFI code 25 may be updated using the CD medium 18a onto which data is written by the standardized method. Since it is required only to write data on the CD medium 18a by the standardized method, the CD medium 18a used for updating the EFI code 25 may be easily and rapidly prepared.

As described above, the data stored in the CD medium 18a is not accessed in accordance with the EFI code 25 by the standardized method. Therefore, according to the present embodiment, the data stored in the CD medium 18a is copied onto a recording medium which is compatible with the EFI code 25. The flash memory 15 is prepared for copying data stored in the CD medium 18a. The name “CD medium” of the CD medium 18a is used as a collective name of the CD to which additional writing is not allowed. Since the recording medium to which additional writing is not allowed may be any recording medium as long as data written onto the recording medium is not accessed in accordance with the EFI code 25 by the standardized method, the recording medium is not limited to the CD medium 18a.

Copying the data stored in the CD medium 18a onto the flash memory 15 is performed in accordance with the embedded OS 26 stored in the flash memory 14. Unlike OSs for an information processing device (computer), the embedded OS 26 satisfies a real time operation capability and compact functionality which allows the embedded OS 26 to be operated using a small amount of memory. Further, the embedded OS 26 has a high reliability and stability. In this respect, the embedded OS 26 is adopted to copy the data stored in the CD medium 18a onto the flash memory 15 more reliably in a shorter period of time.

The embedded OS 26 is used only for copying the data stored in the CD medium 18a onto the flash memory 15. Thus, according to the present embodiment, the data stored in the CD medium 18a is automatically copied onto the flash memory 15 in accordance with the embedded OS 26. The flash memory 15 and other flash memories 13 and 14 are initialized in the FAT format so that data stored therein may be accessed in accordance with the EFI code 25. The embedded OS 26 may be executed in accordance with settings, such as a copy source of data and a copy destination of data so that the embedded OS 26 may be available for different hardware resources of the server 1.

According to the present embodiment, activation of the embedded OS 26 is controlled in accordance with the boot mode information 23a managed by the MMB 23. A program which is initially executed by the CPU 11 is the EFI code 25 upon turning ON of the power supply or the system reset. In this respect, according to the present embodiment, a boot control program 25a, which is a subprogram for activating the embedded OS 26 as needed by referring to the boot mode information 23a managed by the MMB 23, is embedded in the EFI code 25. The description on a loader which is a program for reading out the EFI code 25 is omitted.

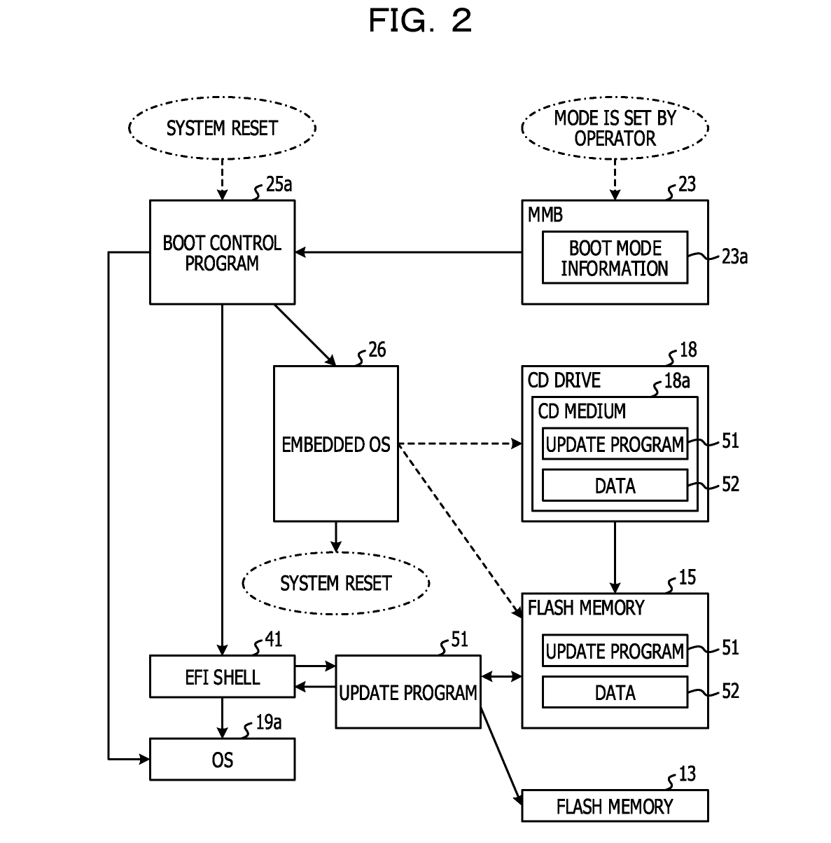

FIG. 2 is a diagram illustrating an example of functions of a boot control program included in an EFI code. Here, an example of functions of the boot control program 25a included in the EFI code 25 and an example of functions of each program directly or indirectly activated by the boot control program 25a will be described in detail with reference to FIG. 2.

According to the present embodiment, an update program 51 which updates the EFI code 25 and data 52 used for updating the EFI code 25 in accordance with the update program 51 are written onto the CD medium 18a, as update data for the EFI code 25. Data 52 is, for example, new program data to be substituted for a portion of the EFI code 25.

Due to turning ON of the power supply or the system reset, the CPU 11 reads the EFI code 25 from the flash memory 13 to write the EFI code 25 into the memory 12 and starts execution of the EFI code 25. The EFI code 25 activated by performing the operations as described above hands over (transfer) the control to the boot control program 25a, that is, the CPU 11 starts processing in accordance with the boot control program 25a.

The CPU 11 obtains the boot mode information 23a from the MMB 23 in accordance with the boot control program 25a. According to the present embodiment, the boot mode information 23a is defined to represent, as a boot mode, any one of a normal mode, maintenance mode, and shell mode.

The normal mode is a mode for activating the OS 19a stored in the hard disk drive 19 subsequently after the EFI code 25 is activated. Accordingly, the boot control program 25a performs booting that reads the OS 19a from the hard disk drive 19. The control is transferred to the activated OS 19a due to the booting.

The maintenance mode is a mode for activating the embedded OS 26. Accordingly, the boot control program 25a activates the embedded OS 26. The control should be transferred to the embedded OS 26 due to the activation of the embedded OS 26. Thus, execution of the EFI code 25 ends.

By activating embedded OS 26, the CPU 11 controls the CD drive 18 through the chipset 16 and the USB/SATA controller 17 to copy the update program 51 and data 52 stored in the CD medium 18a into the flash memory 15. In accordance with the embedded OS 26, the CPU 11 performs the system reset after copying the update data into the flash memory 15. Accordingly, the EFI code 25 is activated again and the control is handed over to the boot control program 25a. The reason why the system reset is automatically performed in accordance with the embedded OS 26 is to further suppress a workload of the operator.

The shell mode is a mode for activating a shell 41 of the EFI code 25. Accordingly, the boot control program 25a hands over the control to the shell 41. The shell 41 is an application program included in the EFI code 25. Hereinafter, in order to avoid confusion, descriptions will be made on an assumption that the EFI code 25 is constituted by the boot control program 25a, the shell 41, and other portion except for the boot control program 25a and the shell 41. The other portion except for the boot control program 25a and the shell 41 is referred to as an “EFI code body”.

A shell is a program for recognizing an instruction through manipulation by the operator and providing functions in response to the recognized instruction. The shell 41 of the EFI code 25 provides a command line interface (CLI). Accordingly, the operator may input a command using the input device 31 and instruct to execute the input command while viewing a screen of the monitor 32 connected to the server 1, upon setting of the shell mode, that is, while executing the shell 41.

When it is intended to execute the update program 51 stored in the flash memory 15, the operator manipulates the input device 31 to access the flash memory 15 and instructs to execute the update program 51 stored in the flash memory 15. Upon the instruction, in accordance with the EFI code body to which the control is transferred from the shell 41, the CPU 11 activates the update program 51 stored in the flash memory 15. As a result, the control is handed over to the update program 51. When the operator has instructed to activate the OS 19a stored in the hard disk drive 19, in accordance with the EFI code body to which the control is transferred from the shell 41, the CPU 11 activates the OS 19a.

In accordance with the activated update program 51, the CPU 11 updates the EFI code 25 stored in the flash memory 13 using the data 52 on the flash memory 15. After updating the EFI code 25, the execution of the update program 51 ends and the control is returned to the EFI code 25.

It does not usually need to repeatedly execute the embedded OS 26 and the shell 41. Therefore, when the boot mode information 23a managed by the MMB 23 indicates the maintenance mode or the shell mode, the CPU 11 automatically updates the boot mode information 23a in accordance with the boot control program 25a. The boot mode indicated by the boot mode information 23a is changed from the maintenance mode to the shell mode or from the shell mode to the normal mode due to the automatic updating of the boot mode information 23a. The automatic updating of the boot mode information 23a from the maintenance mode to the shell mode is performed, for example, before activation of the embedded OS 26. The automatic updating of the boot mode information 23a from the shell mode to the normal mode is performed, for example, before activation of the shell 41.

The boot mode may be designated using mechanical equipment (e.g., a switch or the input device 31). However, designating the boot mode by the mechanical equipment has a problem in that the manipulation of the mechanical equipment may be burdensome or the operator may forget the manipulation. Thus, according to the present embodiment, the operator may update the EFI code 25 more easily and rapidly through the automatic updating of the boot mode information 23a.

There may be many servers 1 for which the EFI code 25 is required to be updated. However, the boot mode information 23a maintained in the MMB 23 may be updated using a terminal device connected to the network 35. Therefore, the boot mode information 23a of each server 1 may be rapidly updated. This is also the reason why the boot mode is set by using the boot mode information 23a.

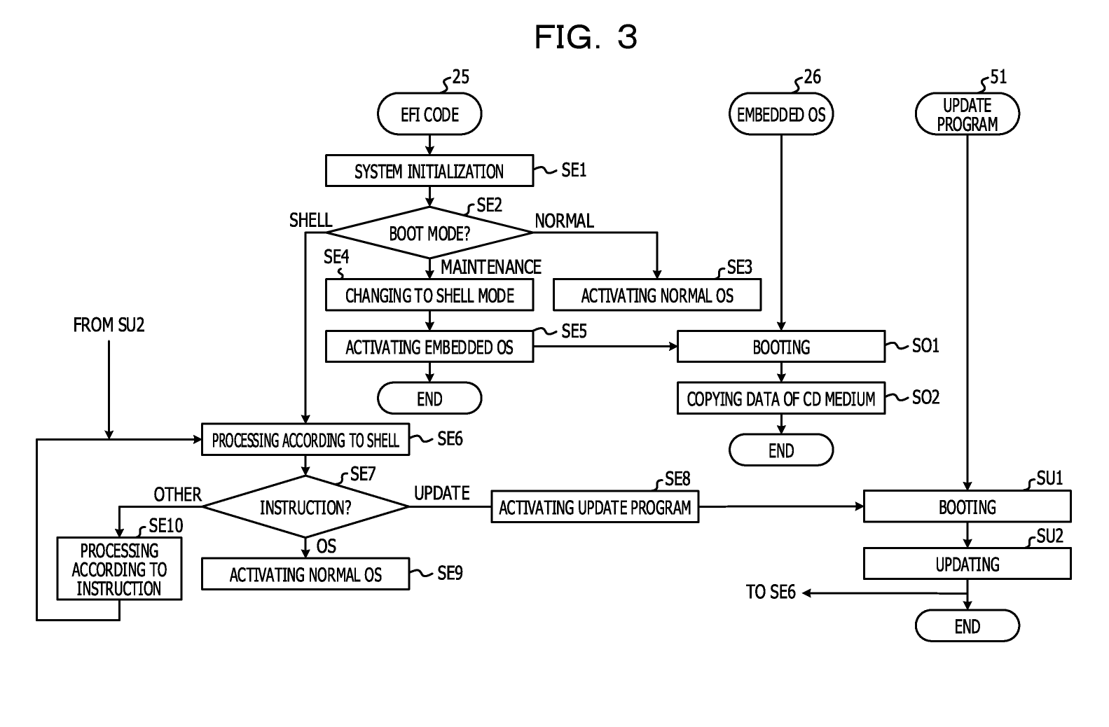

FIG. 3 is a flowchart illustrating an example of a flow of processing executed in accordance with an EFI code, an embedded OS and an update program. Finally, processing executed in accordance with the EFI code 25, the embedded OS 26, and the update program 51 by the control of the boot control program 25a included in the EFI code 25 will be described in detail with reference to FIG. 3.

The EFI code 25, the embedded OS 26, and the update program 51 are programs executed by the CPU 11. Accordingly, arrows directing from the EFI code 25 to the embedded OS 26, from the EFI code 25 to the update program 51, and from the update program 51 to the EFI code 25 illustrated in FIG. 3 indicate relationships of control transfer.

The EFI code 25 is read from the flash memory 13 to the memory 12 to be activated due to the turning ON of the power supply or the system reset. First, the CPU 11 performs system initialization for the CPU 11, the chipset 16, and the like in accordance with the EFI code body of the activated EFI code 25 (SE1). The control is transferred to the boot control program 25a after the system initialization.

In accordance with the boot control program 25a to which the control is transferred, the CPU 11 obtains the boot mode information 23a from the MMB 23 to determine the boot mode indicated by the boot mode information 23a (SE2).

When the boot mode information 23a indicates the normal mode, the boot mode is determined as the normal mode at SE2, and the CPU 11 performs booting in the normal mode in accordance with the boot control program 25a. Specifically, the CPU 11 activates the OS 19a stored in the hard disk drive 19 in accordance with the EFI code body (SE3). The control is transferred to the OS 19a due to the activation of the OS 19a. Accordingly, the process that follows SE3 is omitted.

When the boot mode information 23a indicates the maintenance mode, the boot mode is determined as the maintenance mode at SE2, and the process proceeds to SE4.

In accordance with the boot control program 25a, the CPU 11 requests the MMB 23 to change the boot mode indicated by the boot mode information 23a maintained in the MMB 23 from the maintenance mode to the shell mode (SE4). Next, the CPU 11 activates the embedded OS 26 in accordance with the boot control program 25a (SE5). Thereafter, the execution of the EFI code 25 ends. The control is handed over to the activated embedded OS 26 due to ending of execution of the EFI code 25.

In the activation of the embedded OS 26, for example, the CPU 11 executes a loader of the embedded OS 26, which is stored in the flash memory 14, in accordance with the EFI code 25. The CPU 11 performs booting in accordance with the loader (SO1). Specifically, the CPU 11 reads the embedded OS 26 from the flash memory 14 to the memory 12. The embedded OS 26 is activated due to the booting and the activated embedded OS 26 obtains the control.

In accordance with the embedded OS 26, the CPU 11 controls the CD drive 18 through the chipset 16 and the USB/SATA controller 17 to copy the update program 51 and the data 52 stored in the CD medium 18a mounted on the CD drive 18 into the flash memory 15 (502). Thereafter, the CPU 11 executes the system reset in accordance with the embedded OS 26, and ends the execution of the embedded OS 26. Accordingly, the EFI code 25 is activated again.

At SE2, when it is determined that the boot mode information 23a indicates the shell mode as the boot mode, the CPU 11 activates the shell 41 in accordance with the boot control program 25a. Before activating the shell 41, the CPU 11 requests, in accordance with the boot control program 25a, the MMB 23 to change the boot mode indicated by the boot mode information 23a maintained in the MMB 23 from the shell mode to the normal mode.

The control is transferred to the shell 41 due to the activation of the shell 41. In accordance with the shell 41, the CPU 11 displays a screen of the CLI on the monitor 32 and interprets the instruction issued by the operator through the input device 31 (SE6). Accordingly, when the operator has performed a manipulation for issuing a certain instruction by using the input device 31, the CPU 11 interprets the instruction and determines the interpreted instruction in accordance with the shell 41 (SE7).

When the operator has issued an instruction to activate the update program 51, the CPU 11 determines that the instruction to activate the update program 51 is issued at SE7 and performs activation of the update program 51 in accordance with the shell 41 (SE8). Specifically, the CPU 11 activates the update program 51 in accordance with the EFI code body. The control is transferred to the update program 51 due to the activation of the update program 51.

In the activation of the update program 51, the CPU 11 executes a loader of the update program 51 in accordance with the EFI code 25. The CPU 11 performs booting in accordance with the loader (SU1). Specifically, the CPU 11 reads the update program 51 from the flash memory 15 to the memory 12. The update program 51 is activated due to the booting and the activated update program 51 obtains the control. In accordance with the update program 51, the CPU 11 updates the EFI code 25 stored in the flash memory 13 using the data 52 stored in the flash memory 15 (SU2). After updating the EFI code 25 in accordance with the update program 51, the CPU 11 automatically ends the execution of the update program 51. Accordingly, the control returns to the EFI code 25.

At SE7, when it is determined that the operator has issued an instruction to activate the OS 19a, the CPU 11 performs activation of the OS 19a in accordance with the shell 41 (SE9). Specifically, the CPU 11 activates the OS 19a in accordance with the EFI code body. Since the control is transferred to the OS 19a due to the activation of the OS 19a, the process that follows SE9 is omitted similarly to SE3.

When the operator has issued an instruction other than the instruction to activate the update program 51 and the instruction to activate the OS 19a, it is determined, at SE7, that the operator has issued an instruction other than those instructions to activate the update program 51 and the OS 19a. In accordance with the shell 41, the CPU 11 executes processing according to the issued instruction (SE10). Thereafter, the process goes back to SE6. Accordingly, the operator may cause the CPU 11 to execute, in accordance with the EFI code 25, processing other than updating of the EFI code 25.

According to the present embodiment, the firmware to be updated is set as the EFI code 25 but the firmware to be updated is not limited to the EFI code 25. Further, the processing executed in accordance with the EFI code 25 is not limited to updating of the EFI code 25 itself.

For example, the PCIe switch 21 is provided with a memory 21a in which firmware is stored. Accordingly, data to be used for updating the firmware of the PCIe switch 21 may be stored in the CD medium 18a, and the firmware update of the PCIe switch 21 using the CD medium 18a may be performed in accordance with the EFI code 25.

According to the present embodiment, the flash memory 15 is prepared as a write destination for data stored in the CD medium 18a but the write destination for the data may be a recording medium other than the flash memory 15. When the flash memory 13 has an available space, the flash memory 13 may be used as the write destination for the data.

According to the present embodiment, the boot control program 25a is embedded in the EFI code 25 which is a target to be updated. However, the boot control program 25a may be prepared as a program separated from the EFI code 25. When the boot control program 25a is prepared as a program separated from the EFI code 25, the CPU 11 may be caused to execute the boot control program 25a due to turning ON of the power supply or the system reset. In such a case, the data stored in the CD medium 18a may be copied in accordance with the embedded OS 26 and then the copied update program 51 may be automatically executed. In this respect, the transition to the shell mode, that is, activation of the shell 41 may be omitted. Since a firmware equipped with a self-update function is updated by simply executing the firmware in a self-update mode, transition to a state such as the shell mode is unnecessary.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device, comprising:
a first recording medium configured to store therein data in a first format;
a first storage unit configured to store therein a first program for causing the information processing device to access data in the first format and not causing the information processing device to access data in a second format different from the first format;
a second storage unit configured to store therein a second program for causing the information processing device to access data in the first format and causing the information processing device to access data in the second format; and
a processor configured to
select, as a target program to be executed, one of the first program and the second program, and
execute, upon selecting the second program as the target program, the second program to read first data stored in a second recording medium in the second format and write the first data in the first recording medium in the first format, the second recording medium being different from the first recording medium.

2. The information processing device according to claim 1, further comprising:
a storage device configured to store therein target information indicating the target program,
wherein
the processor is configured to
select the target program with reference to the target information stored in the storage device, and
update the target information stored in the storage device when the second program is executed.

3. The information processing device according to claim 1, wherein the processor is configured to
automatically end the execution of the second program after writing the first data in the first recording medium.

4. The information processing device according to claim 2, wherein the processor is configured to
activate, when the second program is included in the target program indicated by the target information stored in the storage device, the second program after activating the first program.

5. The information processing device according to claim 1, wherein the processor is caused to perform the selection by a fourth program.

6. A computer-readable recording medium having stored therein a program for causing a computer to execute a process, the process comprising:
selecting, as a target program to be executed, one of a first program and a second program, the first program causing the computer to access data in a first format and not causing the computer to access data in a second format different from the first format, the second program causing the computer to access data in the first format and causing the computer to access data in the second format; and
executing, upon selecting the second program as the target program, the second program to read first data stored in a second recording medium in the second format and write the first data in a first recording medium in the first format, the second recording medium being different from the first recording medium.

7. A method for moving data, the method comprising:
selecting by a computer, as a target program to be executed, one of a first program and a second program, the first program causing the computer to access data in a first format and not causing the computer to access data in a second format different from the first format, the second program causing the computer to access data in the first format and causing the computer to access data in the second format; and
executing, upon selecting the second program as the target program, the second program to read first data stored in a second recording medium in the second format and write the first data in a first recording medium in the first format, the second recording medium being different from the first recording medium.
